(19) United States
(12) Patent Application Publication
(10) Pub. No.: US 2005/0280276 A1
(43) Pub. Date: Dec. 22, 2005

(54) Fuel filler doors

(75) Inventor: Keith McComsey, Chesterland, OH (US)

Correspondence Address: ROETZEL & ANDRESS, 1375 EAST 9TH STREET, CLEVELAND, OH, 44114, US

(73) Assignee: Anchor Tool & Die Company

(21) Appl. No.: 10/874,299

(22) Filed: Jun. 22, 2004

(51) Int. Cl. B62D 25/00

(52) U.S. Cl. 296/97.22

(57) ABSTRACT

Fuel filler doors for automobile and other vehicle bodies have advanced design and construction using one-sided welding, adhesives and molded metal for reduced material requirements, strength and stiffness, and improved dimensional tolerances and aesthetics.

### FIELD OF THE INVENTION

The present invention pertains generally to the design and manufacture of a component part of a vehicle body, and more particularly to fuel filler doors which cover a fuel filling port of a vehicle and which fit with a vehicle exterior body or shell.

### BACKGROUND OF THE INVENTION

Fuel filler doors on vehicle bodies are designed to cover and conceal the fuel filling port. To make the doors as inconspicuous as possible, it is desirable that the periphery of the door closely match the opening in the body. This matching is made more difficult by the fact that the door must be mounted on a hinge internal to the door and body, and the further requirement that the door be positionable by the hinge mount in both the opened and closed positions. Also, because fuel filler doors are manually handled on a frequent basis, and because aesthetics are important, the edges must be appropriately finished. This has been done in one way by forming a hemmed edge of the exterior skin of the door around the edges of an interior plate and about a periphery of the door. This requires a two-part door construction of the outer skin and the interior plate, and the time and expense of forming the hem about the periphery. The interior plate also adds substantial weight to the door. Another approach is to form a flange about a perimeter of the door panel which extends inward perpendicularly from the exterior of the door panel. The interior of the flange provides a surface for mounting and spot welding internal structural components to the door. This also requires additional material on the internal components to meet with the flange, and present the difficulty of forming multiple spot welds over the small area of the flange. Also, the terminal edge of the flange is typically unfinished and can be rough or sharp which is undesirable given that fuel filler doors are frequently handled.

Because fuel filler doors require internal components such as a hinge mount and latch engagement, these components have in the past been combined in a single structure which is attached to the interior of the door, typically by attachment at the periphery. This design approach requires excess material between the different components.

Hinge and latch mechanisms of fuel filler doors are in many instances rather crude, such as use of a heavy spring which slams the door shut against a bumper, and no latch mechanism at all, leaving the fuel cap and line unprotected.

### SUMMARY OF THE INVENTION

In accordance with one aspect of the invention, a fuel filler door is made by use of single surface welds for securement of components and structures to an interior side of the door panel, whereby multiple internal parts, such as a latch, hinge mount and fuel cap holder, are separately attached to the interior of the door panel, and points or areas of attachments of the components are not visible from the exterior of the door panel.

In accordance with another aspect of the invention, a structural adhesive is used to secure components or structures to an interior side of the door panel, whereby multiple internal parts, such as a latch, hinge mount and fuel cap holder, are separately attached to the interior of the door panel, and points or areas of attachments of the components are not visible from the exterior of the door panel.

In accordance with another aspect of the invention, a fuel filler door is made in the form of a single piece of molded metal, with structural and component features molded on an interior side of the door panel, including such features as hinge mounts, latch, fuel cap tether attachment, and reinforced areas.

In accordance with other design features of a fuel filler door of the invention, a dampened spring-biased hinge assembly is provided for mounting internal to a fuel filler door for opening and closing operation of the door. The dampened spring-biased hinge assembly performs smooth automatic opening at a controlled rate of a fuel filler door when released for opening by disengagement of a latch. In one embodiment, the dampened spring-biased hinge assembly is mounted on a door mounting bracket and in contact with an internal portion of the door.

In accordance with another aspect of the invention, there is provided improved hinge and latch mechanisms adapted for use in connection with a fuel filler door, including a dampened torsional spring-biased hinge assembly which performs smooth and controlled opening of the door to an opened position, and which is reset by closure of the door, preferably by engagement of a latch pawl which extends from an interior of the door with a push-activated latch.

These and other aspects of the invention are described in detail with reference to the accompanying drawings.

### DESCRIPTION OF THE DRAWINGS

FIG. 1 is a perspective exterior view of a fuel filler door which can be constructed in accordance with the invention, as installed on a vehicle body;

FIG. 2 is a perspective view of a fuel filler door of the invention in an opened position;

FIGS. 3 and 4 is an interior view of a fuel filler door of the present invention;

FIGS. 5 and 6 are interior views of an alternate embodiment of a fuel filler door of the present invention, and

FIGS. 7 and 8 are top views of a fuel filler door assembly of the present invention.

### DETAILED DESCRIPTION OF PREFERRED AND ALTERNATE EMBODIMENTS

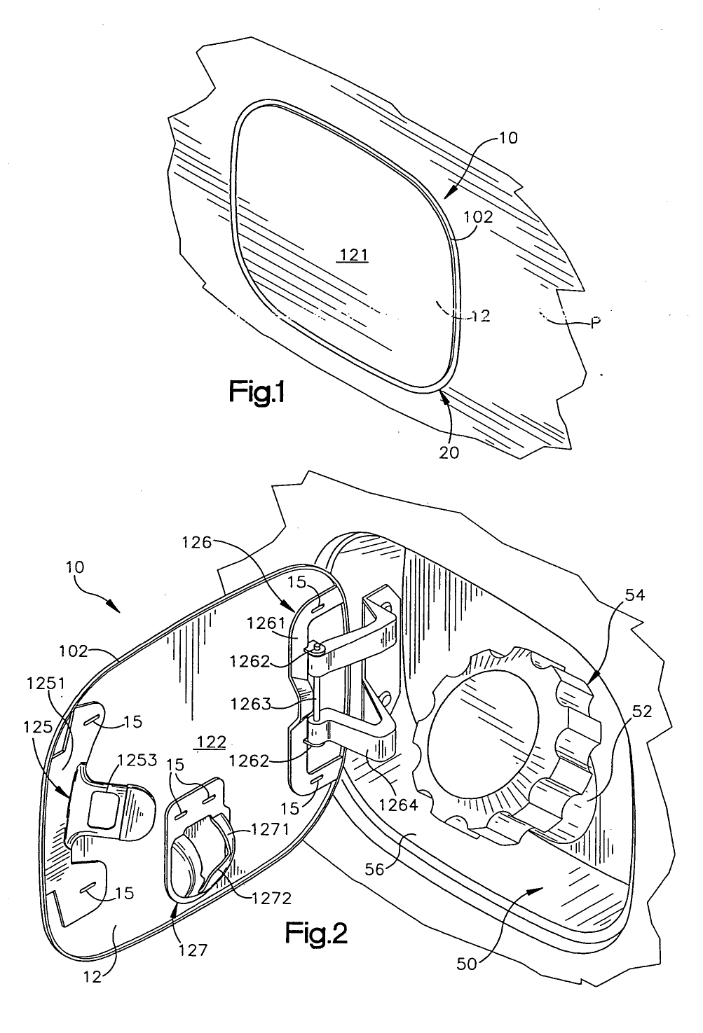

As shown in FIGS. 1 and 2, a fuel filler door, indicated generally at 10 has a door panel 12 with an exterior side 121 and an interior side 122. The exterior side 121 is typically configured to match the contour of a vehicle body panel P in which the door 10 is located. The door panel 12 has a perimeter 102 which fits within an opening 20 in the vehicle body panel P. The opening 20 in the body panel P is most commonly to a fuel port compartment 50 in which the fuel port 52 and fuel cap 54 are located, recessed from the exterior of body panel P. The fuel port compartment has a side wall 56 which extends inward from the opening 20.

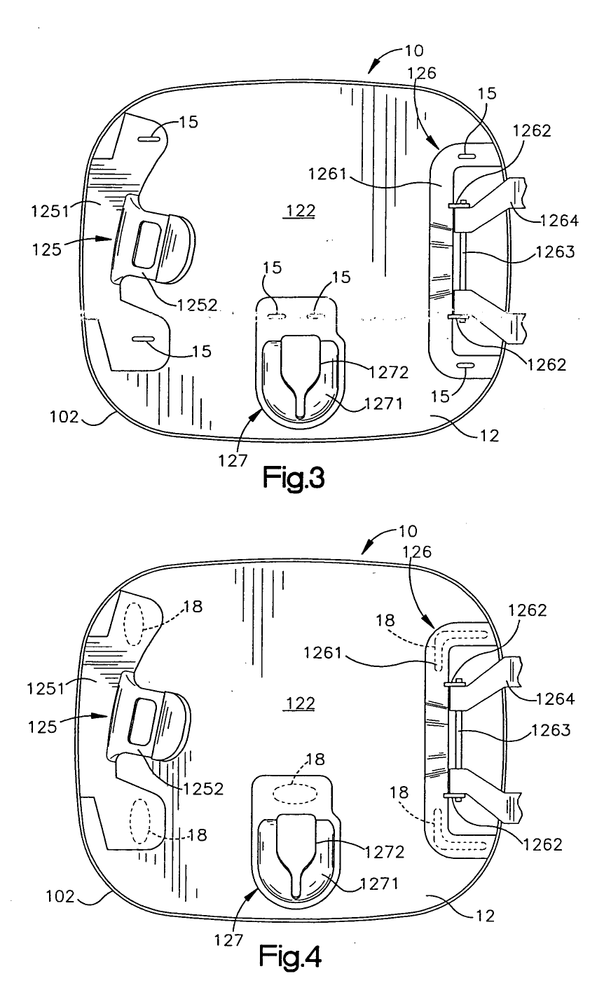

As further shown in FIGS. 2 and 3, there are one or more components attached to the interior side 122 of the door panel 12. For example, a latch engagement structure 125 is attached at one end of the interior side 122 of door panel 12 proximate to the perimeter 102. The latch engagement structure can be fabricated from a single piece of material such as metal, and secured to the surface of the interior side 122 by one or more projection welds as indicated at 15. The projection welds 15 are preferably low profile welds suitable for use with class A surfaces, such as automotive body panels, and further suitable for use with just two material layers, without material alteration of the opposing surface. A preferred type of projection weld or weld process for fabrication of the invention is the Hy-Pak® weld developed by the Newcor Corporation, which uses a high energy short duration weld pulse with a low inertia fast follow-up weld electrode, and requires less force than typical resistance welding. Prior to the present invention, the application and use for this type of weld was for interior tacking of one panel to another, e.g. inside of hem, so that any blemish which was made on the surface opposite the weld projection is not visible underneath the hem. Although widely used on combinations of material layers of three or more, the inventor has discovered that for this particular application which has only two layers of material thickness this type of welding process can be adapted for the secure and permanent attachment of internal components to the door 12, and does not require any reworking or refinishing of the surface of exterior side 121 opposite the welds 15. For example, by selecting appropriate material thickness for the components to be welded to the interior side of the door panel and the corresponding projection of the weld, and adjusting the weld schedule (i.e., current, % heat, clamping forces, etc.), an optimized weld between the two layers can be made without surface blemish or marring of the exterior side 121 of the door panel 12. This includes welding of layers to the interior side of an exterior automotive class A finish body panel, such as fuel filler door panel 12. The welds 15 form and impression or projection on the internal components and bonds the components to the interior side of the door panel without altering a surface of the exterior side of the door panel.

The latch engagement structure 125 includes a base 1251 and an extension 1252 with an opening 1253 which is engaged with a releasable jaw of a latch (not shown) mounted for example inside the opening 20. Other forms of latch engagement structures can be used in accordance with the invention which have any configuration of a base portion which can be welded to the interior side 122 of door 12 and project inwardly for engagement with a latch.

Other components which may be secured to the interior side 122 of the door 12 by such projection welding include a hinge mount 126 and a cap retainer or cap tether attachment structure 127. The hinge mount 126 has a base portion 1261 which fits against the interior side 122 of door 12 and where one or more welds 15 are placed for permanent attachment to door 12. Extending from the base portion 1261 are hinge pin receivers 1262 for receiving a hinge pin 1263. The hinge pin 1263 is held by a bracket 1264 which is attached to the interior of opening 20. The cap retainer or cap tether attachment structure 127, also attached by welds 15, can be located at any suitable area of the interior side 122 of door 12. One design of a cap retainer or cap tether attachment structure 127 has a raised portion 1271 with an opening 1272 therein.

The separate fabrication and attachment of the internal components 125, 126 and 127 is enabled by the use of the described low projection welding, and saves material costs from the prior art approach of incorporating all of the components into a single piece which is attached to the perimeter of the door.

FIG. 4 illustrates an alternate embodiment of the invention wherein the separate internal components 125, 126 and 127 are secured to the interior side 122 of door 12 by a structural adhesive, which is preferably specially adapted for metal and automotive applications, such as BETAMATE 1496 adhesive sold by Dow Automotive, which is applied in locations 18, which may be proximate to the locations of welds 15 or wherever there is contact between the internal components and the interior side 122 of door 12, to permanently bond the components to the door. This type of construction has the advantages of avoiding the necessity of a welding process. Also, the adhesively bonded area of the components to the interior side 122 of door 12 can be greater than that of welds 15 to provide an even stronger structure.

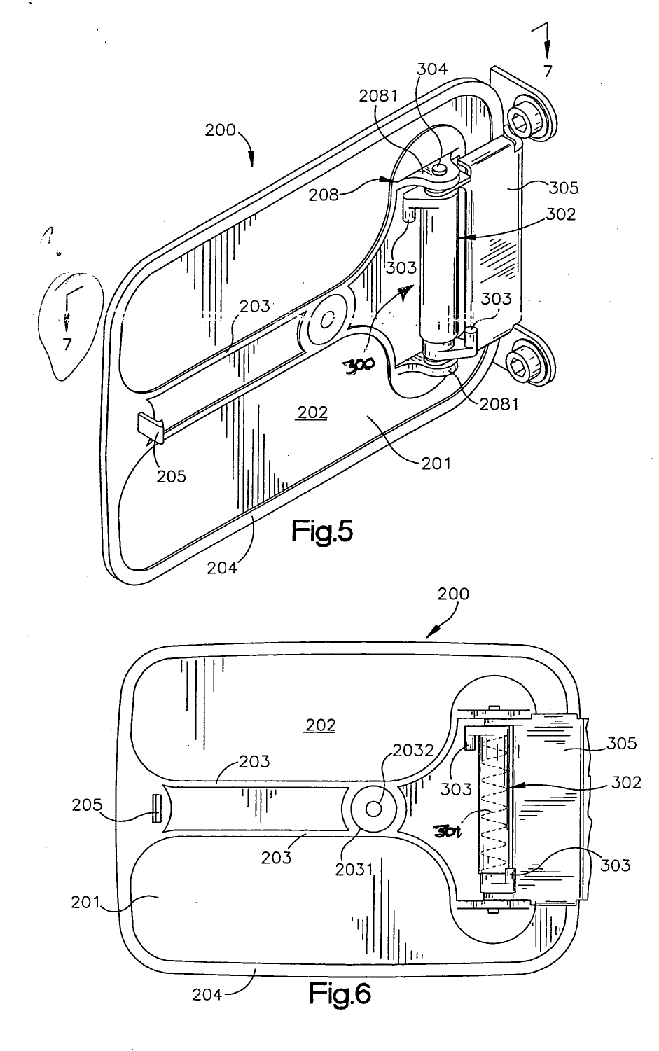

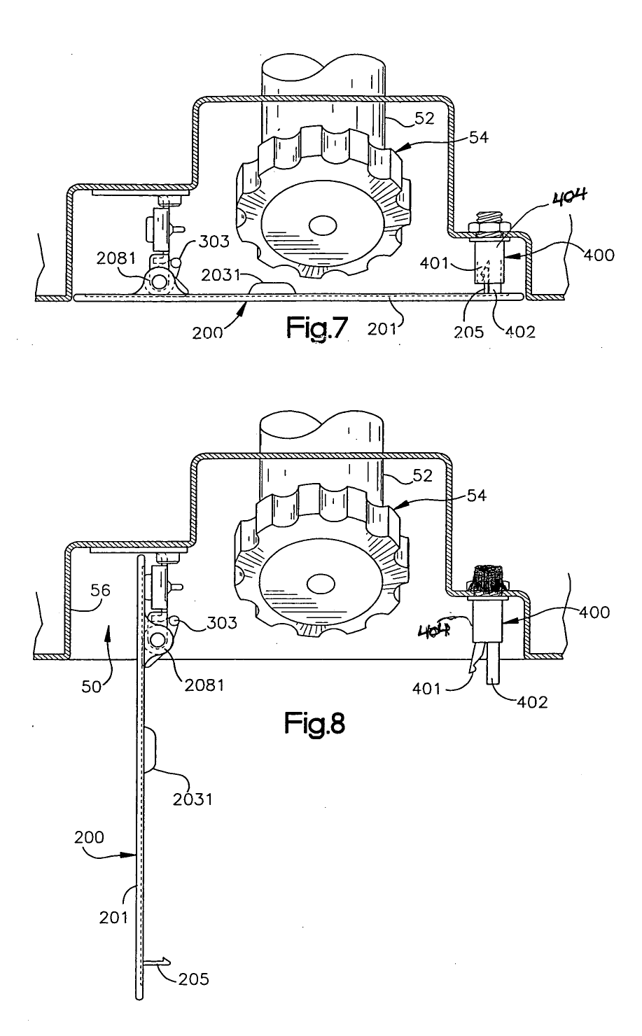

FIGS. 5 and 6 illustrate an alternate embodiment of the invention, which is a molded fuel filler door, indicated generally at 200, which is molded as a single structure or body with a generally planar or curved panel 201 configured to match the contour of the corresponding vehicle body. Other component parts and structural details are integrally molded with the panel 201, such as a perimeter 204 which is preferably of greater thickness than panel 201 for stiffness and strength, and for fit and finish with the vehicle body opening 20. Similarly, raised reinforcement areas 203, in the form of ribs or areas, increase stiffness and strength. A latch engagement pawl 205 projects inward from an interior side 202 of panel 201, and preferably from a raised area 203 for engagement with a latch 400 mounted internal to vehicle body opening 20, as shown in FIGS. 7 and 8. The pawl 205 can be optionally included or excluded from the molded structure of the single piece door 200 depending upon whether a latch is intended to be provided for engagement with the pawl 205.

A preferred form of the molded door 200 of the invention can be produced by molding magnesium, aluminum or zinc alloys. One molding process which utilizes these materials and is suitable for the general configuration of a fuel filler door and the described detailed features is Thixomolding® which is based on the principle that magnesium, aluminum and zinc alloys become semi-solid at temperatures between the liquidus and solidus. Mechanical shearing of the semi-solid metal generates a thixotropic structure that allows these materials to be molded utilizing a process similar to plastic injection molding while eliminating the environmental impacts of die casting. Unlike die casting, thixotropic based metal molding does not require the handling of molten metals in separate melting and transfer systems. This molding method can produce net or near net parts of very high quality, with dimensional stability, low porosity and tighter tolerances with reduced shrinkage, residual stress and component distortion. These attributes make the process ideal for molding of fuel filler doors given the nominally thin part thickness and the various feature components which when molded in greatly reduces the complexity and cost of the entire part and assembly of associated parts.

Another structural feature which can be optionally formed in the molded door 200 is a centrally located raised or reinforcement area 2031 can be provided for attachment of a fuel cap tether line, by for example providing an indentation 2032 into which a plastic plug type fastener at the end of the tether can be inserted or otherwise attached. Another important structure which can be integrally molded with the door 200 as a whole is a hinge mount, indicated generally at 208, to which any type of hinge may be attached for hinged motion of the door. In the example shown, hinge pin mounts 2081 project inward from the interior side 202 of panel 201, and from a raised area 203 thereon, and have openings for receiving the ends of a hinge pin 304. The hinge pin 304 can be installed in combination with any type of hinge.

A preferred embodiment of a hinge 300 is shown, which has a dampened torsion spring 301 in a two-piece axially rotatable housing 302 which has opposed lever arms 303 on its exterior, one of which bears against the interior side 202 of the door 200, and the other of which bears against a hinge bracket 305 through which the hinge pin 304 is mounted. The bracket 305 is mounted to the vehicle body within opening 20. The torsion spring 301 within the housing 302 is biased to push the door 200 to the open position shown in FIGS. 5 and 8, so that when the latch 400 is opened the door 200 is automatically opened by the spring-bias. The torsion spring 301 is positively coiled when the door 200 is closed by manual operation. Inside the housing 302 is a dampening fluid such as oil or grease which creates drag on the relative rotational movement of the two halves of the housing as the spring 301 is coiled and uncoiled in operation, thus controlling the door to move smoothly and relatively slowly about the hinge. The amount of torsion in the spring 301 is preferably sufficient to move and hold the door 200 to the opened position shown in FIGS. 5 and 8. The extent of travel of travel of the door 200 to the opened position can be selected in one way by placement of a bumper 505 within the fuel port compartment 50 for contact with the door 200 as shown in FIG. 8. The hinge mount bracket 305 could also be configured to enable the door 200 to open to a position radially past that shown in FIG. 8, or through an arc greater than ninety degrees.

A preferred latch 400 for use with this embodiment of the invention is a linearly actuated tapered jaw two-position latch which clamps the latch engagement pawl 205 by movement of first jaw half 401 against a second jaw half 402 as the two jaw halves are moved linearly into a latch body 404, into the fully engaged position shown in FIG. 7. The latch 400 is disengaged from pawl 205 by further advancement of the jaw halves 401, 402 into the latch body 404, by for example pressure on the exterior of the door 200 proximate to the latch, causing the jaw halves to eject out of the latch body and release the pawl 205, allowing the hinge 300 to open the door 200.

Although the invention has been shown and described with reference to certain preferred an alternate embodiments, other embodiments and executions of the inventive concepts are within the scope and equivalent scope of the invention as defined by the following claims.

1. A fuel filler door comprising:
a door panel having an exterior side, and interior side, and a perimeter;
a first internal component attached to an interior side of the door panel by at least one weld which forms an impression on the component and bonds the component to the interior side of the door panel without altering a surface of the exterior side of the door panel.

2. The fuel filler door of claim 1 wherein the door panel further comprises a flange at the perimeter.

3. The fuel filler door of claim 1 wherein the first internal component is a hinge mount.

4. The fuel filler door of claim 1 further comprising a second internal component attached to an interior side of the door panel by at least one weld which forms an impression on the component and bonds the component to the interior side of the door panel without altering a surface of the exterior side of the door panel.

5. The fuel filler door of claim 4 wherein the second internal component is a latch pawl.

6. The fuel filler door of claim 1 further comprising a third internal component attached to an interior side of the door panel by at least one weld which forms an impression on the component and bonds the component to the interior side of the door panel without altering a surface of the exterior side of the door panel.

7. The fuel filler door of claim 6 wherein the third internal component is configured to engage a fuel cap or fuel cap tether.

8. The fuel filler door of claim 1 in combination with a hinge operative to open and close the fuel filler door relative to an opening in a vehicle body.

9. The fuel filler door of claim 6 wherein each of the internal components is placed proximate to a perimeter of the door panel.

10. The fuel filler door of claim 6 wherein the internal components are not attached to the perimeter of the door panel.

11. The fuel filler door of claim 1 wherein the first internal component is attached to the interior side of the door panel by two or more welds.

12. The fuel filler door of claim 6 wherein the internal components are attached to the interior side of the door panel by at least two welds.

13. The fuel filler door of claim 3 wherein the hinge mount is connected to a bracket by a hinge pin, and the bracket extends into an opening in which the door fits.

14. The fuel filler door of claim 3 wherein the hinge mount is attached to the interior of the door panel proximate to the perimeter.

15. The fuel filler door of claim 1 comprising two welds between the first internal component and the door panel.

16. The fuel filler door of claim 5 wherein the second internal component is attached to the door panel by two welds.

17. The fuel filler door of claim 6 wherein the third internal component is attached to the door panel by two welds.

18. A fuel filler door comprising:
a door panel having an exterior side, and interior side, and a perimeter;
a first internal component attached to an interior side of the door panel by an adhesive which bonds the first internal component to the interior side of the door panel without altering a surface of the exterior side of the door panel.

19. The fuel filler door of claim 18 wherein the first internal component is a hinge mount.

20. The fuel filler door of claim 18 further comprising a second internal component attached by an adhesive to an interior side of the door panel.

21. The fuel filler door of claim 20 wherein the second internal component is a latch engagement structure.

22. The fuel filler door of claim 18 further comprising a third internal component attached by an adhesive to an interior side of the door panel.

23. The fuel filler door of claim 22 wherein the third internal component is a cap tether attachment point.

24. The fuel filler door of claim 18 wherein the first internal component is not attached to the perimeter of the door panel.

25. The fuel filler door of claim 20 wherein the second internal component is not attached to the perimeter of the door panel.

26. The fuel filler door of claim 22 wherein the third internal component is not attached to the perimeter of the door panel.

27. The fuel filler door of claim 19 in combination with a hinge assembly which engages with the hinge mount.

28. The fuel filler door of claim 19 in combination with a dampened hinge assembly.

29. The fuel filler door of claim 18 wherein the first internal component is attached to the interior side of the door panel by an adhesive located at two different locations between the first internal component and the interior side of the door panel.

30. A single piece molded metal fuel filler door comprising:
a door panel having an exterior side and an interior side and a perimeter, and a nominal thickness between the exterior side and the interior side;
multiple areas on the interior side of the door panel having a thickness greater than the nominal thickness of the door panel, including a perimeter area, a reinforcement area, and a hinge mount area.

31. The single piece molded metal fuel filler door of claim 30 further comprising a cap tether attachment structure formed integrally with the door panel on the interior side of the door panel.

32. The single piece molded metal fuel filler door of claim 30 further comprising a latch pawl formed integrally with the door panel and which projects from the interior side of the door panel.

33. The single piece molded metal fuel filler door of claim 30 further comprising hinge mounts formed integrally with the door panel and which project from the hinge mount area.

34. The single piece molded metal fuel filler door of claim 30 in combination with a dampened hinge assembly.

35. The single piece molded metal fuel filler door of claim 30 made of molded metal.

36. The single piece molded metal fuel filler door of claim 30 in combination with a push-activated latch assembly.

37. A fuel filler door system comprising:
a door panel having an exterior side, and interior side, and a perimeter;
a hinge comprising hinge pin mounts extending from the interior side of the door panel, a hinge pin extending through the hinge pin mounts and through a hinge mount bracket extending from a fuel port compartment which the door panel is dimensioned to cover, a dampened torsion spring in a two-piece rotatable housing about the hinge pin, the housing having lever arms which bear against the interior side of the housing and the hinge mount bracket;
a latch pawl extending from the interior side of the door panel and adapted for engagement with a puch-activated latch mounted in or proximate to the fuel port compartment.
